(19) United States
(12) Patent Application Publication
(10) Pub. No.: US 2015/0130090 A1
(43) Pub. Date: May 14, 2015

(54) Jet Array Aeration Apparatus

(71) Applicant: Solis Hight-tech Ind. (Shenzhen) Ltd., Shenzhen (CN)

(72) Inventors: Chunhou Li, Shenzhen (CN); Liang Jie, Shenzhen (CN); Hongbiao Dong, Shenzhen (CN); Zhijun Liu, Shenzhen (CN); Jianbin Xiao, Shenzhen (CN); Yafei Duan, Shenzhen (CN); Xiaoyong Jie, Shenzhen (CN); Jiasong Zhang, Shenzhen (CN)

(21) Appl. No.: 14/517,939

(22) Filed: Oct. 20, 2014

(30) Foreign Application Priority Data
Nov. 12, 2013 (CN) 201310561236.8

(51) Int. Cl. C02F 1/74; B01F 5/04; B01F 3/04

(52) U.S. Cl. CPC C02F 1/74; B01F 3/04099; B01F 5/04; C02F 2305/02; B01F 2003/04872; B01F 2215/0052
USPC 261/30

(57) ABSTRACT

A jet array aeration apparatus includes a pump, an inlet pipe, an air inlet duct and an outlet pipe installed sequentially. The air inlet duct is a multi-way duct containing an aeration structure which includes a jet ring and a ring-shaped air inlet space formed between the outer wall of the jet ring and the inner wall of the air inlet duct and interconnected to the outlet pipe. The jet ring has plural array via holes for dividing a circular water column flowing through the jet ring into gear-shaped water columns and forming an array vacuum negative-pressure area, so that a large amount of air may be sucked through the air inlet duct to form a large quantity of air bubbles, so as to achieve the aeration effect.

### CROSS-REFERENCE TO RELATED APPLICATIONS

This non-provisional application claims priority under 35 U.S.C. §119(a) on Patent Application No(s). 201310561236.8 filed in China. on Nov. 12, 2013, the entire contents of which are hereby incorporated by reference.

### BACKGROUND OF THE INVENTION

1. Field of the Invention

The present invention relates to a jet array aeration apparatus.

2. Description of the Related Art

To increase the quantity of dissolved oxygen in water and improve the level of convection of the water flow in different layers of water, while enhancing the water quality and activity of water, aeration is applied to water for wastewater treatment, aquaculture, and hydraulic engineering. At present, common aerators include jet aerators, impeller aerators, paddlewheel aerators and microporous aerators, wherein the impeller aerators and jet aerators sprays water out from the aerators, such that the water is in contact with air and mixed with the air to achieve the aeration effect. In addition, the conventional jet aerators applied for aquaculture generally adopt a single air inlet duct (or a venture type injector), and thus having the drawbacks of a high power consumption and a low water flow. The paddlewheel aerators adopt a blade that moves in a shallow water layer to produce waves and increase the contact area of the water surface and air, so as to achieve the aeration effect. The microporous aerators adopt a blower to blow air into water to dissolve oxygen in the water. Although the aeration effect is improved, the microporous aerators require a long oxygen supply pipeline installed on/in the water. When air bubbles produced from the aeration pipe are introduced perpendicularly, the air bubbles with a relatively greater buoyancy result in a shorter dissolving time of the oxygen remained in the water. Since the conventional microporous aerators are generally fixed at the bottom of a water container, therefore the air and water cannot be pushed forward to a broader range, and thus it is difficult to have a large water exchange between the upper and lower layers of water, and it causes higher power consumption.

Therefore, an aeration apparatus with low power consumption and high aeration effect is needed.

### SUMMARY OF THE INVENTION

In view of the aforementioned problems of the prior art, it is a primary objective of the present invention to provide a jet array aeration apparatus to overcome the problems of the prior art.

To achieve the aforementioned objective, the present invention provides a jet array aeration apparatus, comprising a pump, an inlet pipe, an air inlet duct and an outlet pipe, wherein the air inlet duct is a multi-way duct, and the air inlet duct contains an aeration structure installed therein, and the aeration structure includes a jet ring, and a ring-shaped air inlet space is formed between the outer wall of the jet ring and the inner wall of the air inlet duct and interconnected to the outlet pipe directly or indirectly, and the jet ring has a plurality of array via holes formed on an inner wall proximate to an end of the outlet pipe and distributed uniformly around the circumference of the inner wall of the jet ring.

Wherein, the jet ring has a plurality of hollow frameworks uniformly disposed at the middle of the jet ring, a cavity formed at the framework and interconnected to the air inlet space, a gear plate installed on the framework, and a plurality of array framework via holes formed uniformly on both sides of the gear plate, and the framework via holes are interconnected to the cavity of the framework.

Wherein, the air inlet space is sealed by the jet ring with an end having the array via holes, and each array via hole has an outlet hole interconnected to the air inlet space.

Wherein, the gear plate is in an arc shape, and an end of the gear plate is extended and fixed to another gear plate to form a gear plate element, and the gear plate has a conical protrusion farmed at the connecting position of the gear plate, and the lower part of each gear plate has a cross-section in the shape of a conical groove.

Wherein, the jet ring has one or more latch positions defined on the external surface of the jet ring.

Wherein, the ratio of the internal diameter of the outlet pipe to the internal diameter of the inlet pipe is greater than 1.1:1.

The present invention has the following advantages and effects: In the present invention, the array via holes 9 are formed on the jet ring 3, so that the circular water column is cut by the array via holes 9 into a gear-shaped water column after water flows through the jet ring 3, and an array vacuum negative-pressure area is formed between the gears of the gear-shaped water column. Therefore, a large amount of air is sucked through the air inlet duct for the aeration effect, so as to achieve the energy-saving, environmental friendly, and light and convenient effects. The aeration effect of the present invention is better in an application for a large water flow.

### BRIEF DESCRIPTION OF THE DRAWINGS

FIG. 1 is a schematic view of an aeration structure of the present invention;

FIG. 2 is a cross-sectional view of an installation position of an aeration structure of the present invention;

FIG. 3 is a schematic view of a jet array aeration apparatus of the present invention, when oxygen is sucked through an array via hole during an operation;

FIG. 4 is a schematic view of a jet array aeration apparatus of the present invention, when oxygen is sucked through a framework via hole during an operation; and

FIG. 5 is a schematic view of a jet ring of a jet array aeration apparatus of the present invention.

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

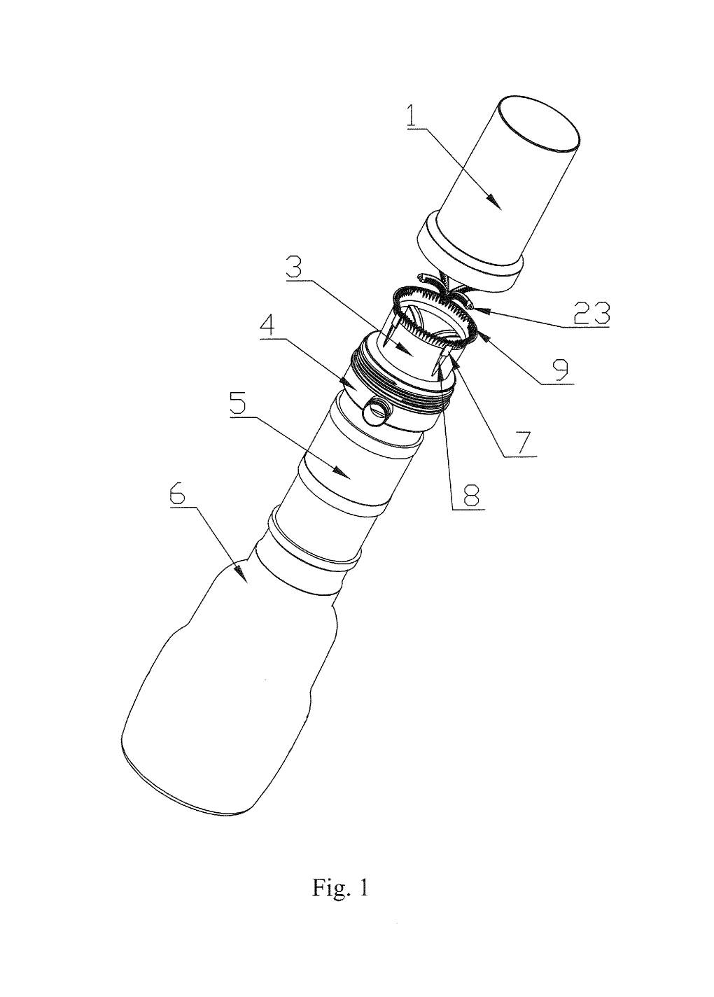

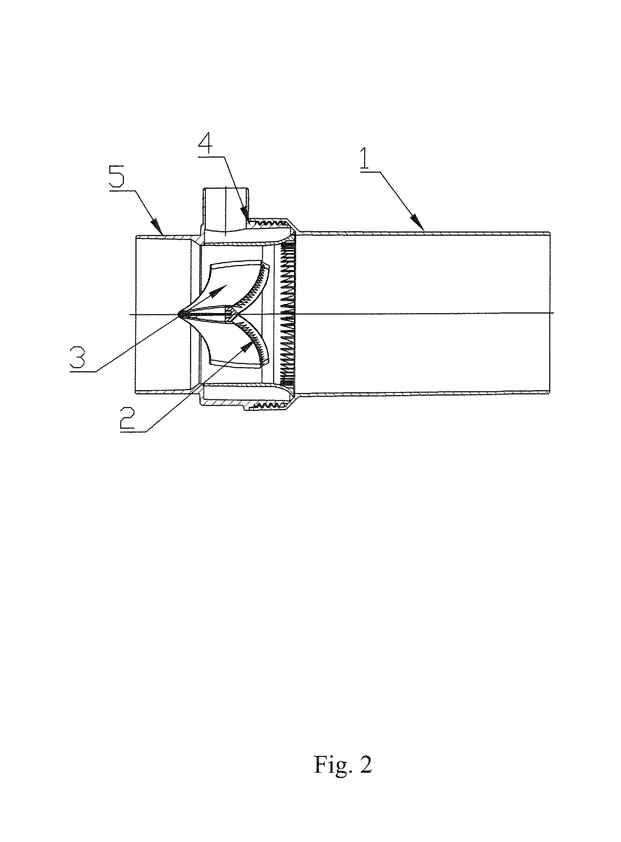

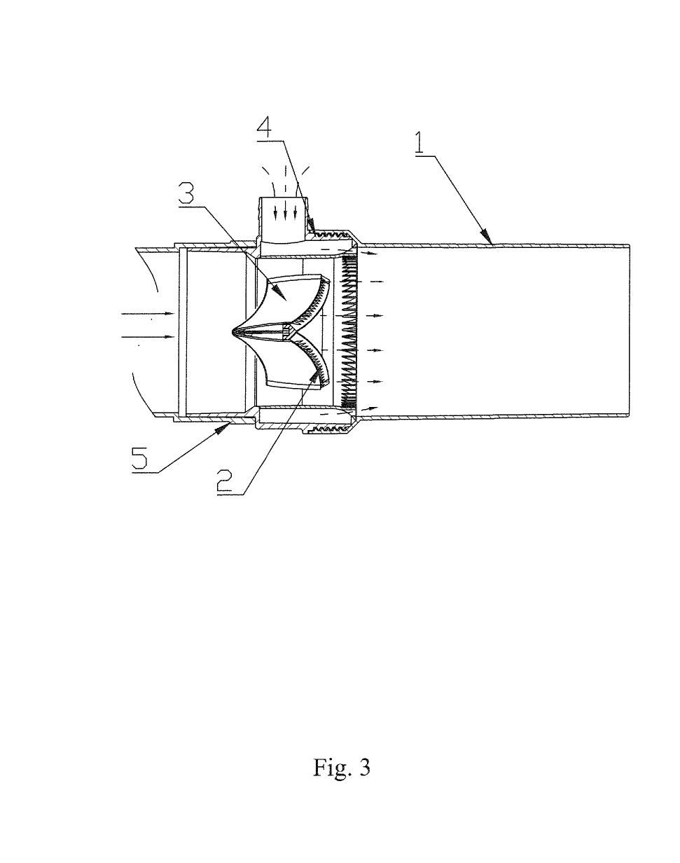

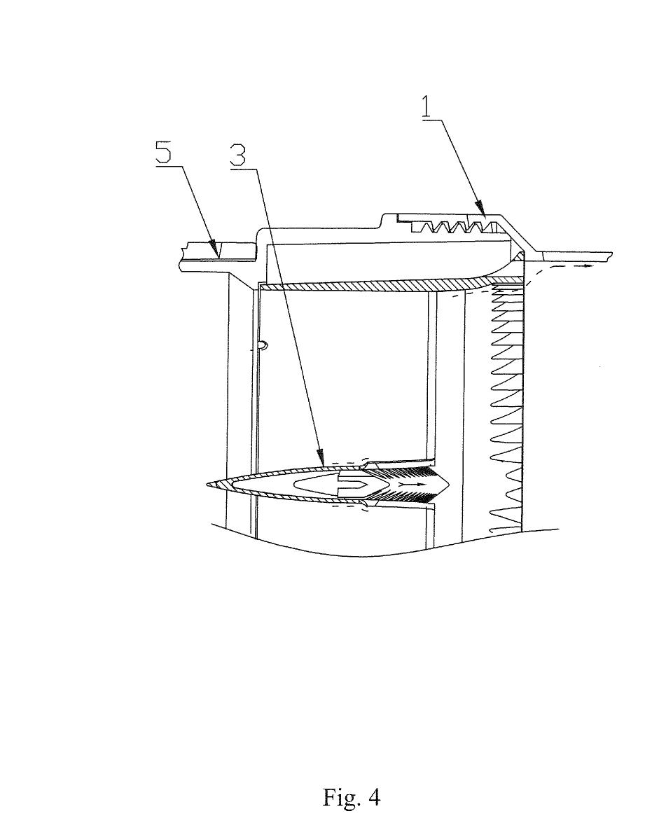

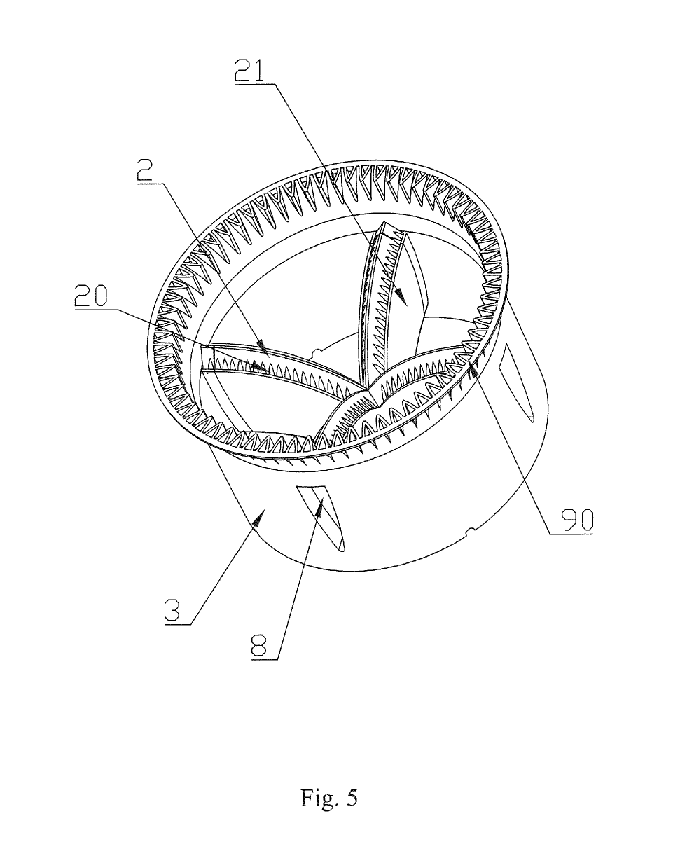

With reference to FIGS. 1 to 5, the jet array aeration apparatus comprises a pump 6, an inlet pipe 5, an air inlet duct 4 and an outlet pipe 1, wherein and the air inlet duct 4 is a multi-way duct, and the air inlet duct 4 contains an aeration structure installed therein, and the aeration structure includes a jet ring 3, and a ring-shaped air inlet space formed between the outer wall of the jet ring 3 and the inner wall of the air inlet duct and interconnected to the outlet pipe directly or indirectly, and the jet ring 3 has a plurality of array via holes 9 formed on an inner wall proximate to an end of the outlet pipe, and the via hole 9 has a cross-section in a circular shape, a rectangular shape, a trapezium shape, an elliptical shape, a semicircular shape or any other shape. The array via holes 9 are distributed uniformly around the circumference of the inner wall of the jet ring 3.

Through the array via holes 9 formed on the jet ring 3, the circular water column is cut by the array via holes 9 into a gear-shaped water column after water flows through the jet ring 3, and an array vacuum negative-pressure area is formed between the gears of the gear-shaped water column. Under the effect of the negative pressure, the large amount of air sucked through the air inlet duct 4 forms a large quantity of air bubbles, and the air bubble generally has a diameter of 1-5 mm, and thus producing the aeration effect and achieving the energy-saving, environmental friendly, light and convenient features. The present invention has a better aeration effect in an application with a large water flow.

In a preferred embodiment, the jet ring 3 includes a plurality of hollow frameworks 21 disposed uniformly at the middle of the jet ring 3, and the framework 21 has a cavity 8 interconnected with the air inlet space, and each framework 21 has a gear plate 2 installed thereon, and the gear plate 2 includes a plurality of array framework via holes 20 formed uniformly on both sides of the gear plate 2, and the framework via holes 20 are interconnected with the cavity of the framework. A water column passing through the framework 21 is cut and divided, and the cutting position becomes a vacuum negative-pressure area. A large quantity of air bubbles is formed after a large amount of air is sucked through the air inlet duct 4 and the cavity 8 into the jet ring 3, and the water column passing through the array via hole 9 is divided into gear-shaped water columns, and an array vacuum negative-pressure area is formed between the gear-shaped water columns. Under the effect of a negative pressure, the large amount of air sucked through the air inlet duct 4 forms a large quantity of air bubbles. With the oxygen suction by the negative pressure, oxygen can be dissolved into water effectively to enhance the aeration effect. Unlike the prior art that requires an additional oxygen pump and consumes much energy, the present invention simply makes use of the water flow to produce a plurality of negative pressure areas at multiple arrays, so as to suck a large amount of air to produce a large quantity of air bubbles, and achieve the energy-saving, environment friendly, light and convenient features.

In a preferred embodiment, the air inlet space is sealed by an end of the jet ring 3 having the array via hole 9, and each array via hole 9 has an outlet hole 90 interconnected with the air inlet space. Such arrangement allows the air entering into the outlet hole 90 too precisely enter into the gap of the corresponding gear-shaped water column.

In a preferred embodiment, the gear plate 2 is in an arc shape, and an end of the gear plate 2 is extended and fixed to another gear plate to form a gear plate element, and the gear plate 2 has a conical protrusion formed at a connecting position of the gear plate 2, and the lower part of each gear plate 2 has a cross-section in the shape of a conical groove 23, and the framework via hole 20 is interconnected with the groove 23, and the groove 23 is interconnected with the cavity 8, so that air passes sequentially through the air inlet space, the cavity 8, the groove 23 and the framework via hole 20 to form the air bubble.

In a preferred embodiment, the jet ring 3 has one or more latch positions 7 defined on the external surface of the jet ring 3. With the latch positions 7, the jet ring 3 can be installed onto the air inlet duct 4 easily.

In a preferred embodiment, the ratio of the internal diameter of the outlet pipe 1 to the internal diameter of the inlet pipe 5 is greater than 1.1:1, and the outlet pipe 5 has a length of 50 mm, and the outlet pipe 1 having an internal diameter greater than that of the inlet pipe 5 facilitates the formation of the air bubbles.

While the invention has been described by means of specific embodiments, numerous modifications and variations could be made thereto by those skilled in the art without departing from the scope and spirit of the invention set forth in the claims.

What is claimed is:

1. A jet array aeration apparatus, including a pump, an inlet pipe, an air inlet duct and an outlet pipe installed sequentially, and the air inlet duct being a multi-way duct, characterized in that the air inlet duct contains an aeration structure installed therein, and the aeration structure includes a jet ring, and a ring-shaped air inlet space is formed between the outer wall of the jet ring and the inner wall of the air inlet duct and interconnected to the outlet pipe directly or indirectly, and the jet ring has a plurality of array via holes formed on an inner wall proximate to an end of the outlet pipe and distributed uniformly around the circumference of the inner wall of the jet ring.

2. The jet array aeration apparatus of claim 1, wherein the jet ring has a plurality of hollow frameworks uniformly disposed at the middle of the jet ring, a cavity is formed at the framework and interconnected to the air inlet space, a gear plate is installed on the framework, and a plurality of array framework via holes is formed uniformly on both sides of the gear plate, and the framework via holes are interconnected to the cavity of the framework.

3. The jet array aeration apparatus of claim 1, wherein the air inlet space is sealed by the jet ring with an end having the array via holes, and each array via hole has an outlet hole interconnected to the air inlet space.

4. The jet array aeration apparatus of claim 3, wherein the gear plate is in an arc shape, and an end of the gear plate is extended and fixed to another gear plate to form a gear plate element, and the gear prate has a conical protrusion formed at the connecting position of the gear plate, and the lower part of each gear plate has a groove which has a conical cross-section shape.

5. The jet array aeration apparatus of claim 3, wherein the jet ring has one or more latch positions defined on the external surface of the jet ring.

6. The jet array aeration apparatus of claim 3, wherein the ratio of the internal diameter of the outlet pipe to the internal diameter of the inlet pipe is greater than 1.1:1.

7. The jet array aeration apparatus of claim 2, wherein the air inlet space is sealed by the jet ring with an end having the array via holes, and each array via hole has an outlet hole interconnected to the air inlet space.

8. The jet array aeration apparatus of claim 3, wherein the gear plate is in an arc shape, and an end of the gear plate is extended and fixed to another gear plate to form a gear plate element, and the gear plate has a conical protrusion formed at the connecting position of the gear plate, and the lower part of each gear plate has a groove which has a conical cross-section shape.

9. The jet array aeration apparatus of claim 7, wherein the jet ring has one or more latch positions defined on the external surface of the jet ring.

10. The jet array aeration apparatus of claim 7, wherein the ratio of the internal diameter of the outlet pipe to the internal diameter of the inlet pipe is greater than 1.1:1.
